(19) United States
(12) Patent Application Publication
(10) Pub. No.: US 2008/0133545 A1
(43) Pub. Date: Jun. 5, 2008

(54) TERMINAL DEVICES WITH FUNCTION OF DISTRIBUTING DATA AND METHOD AND SYSTEM FOR DISTRIBUTING MULTIMEDIA DATA USING THE SAME

(75) Inventors: Bong Wan KIM, Daejeon (KR); Yoo Kyoung LEE, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 11/950,035

(22) Filed: Dec. 4, 2007

(30) Foreign Application Priority Data
Dec. 4, 2006 (KR) 10-2006-0121587
Sep. 21, 2007 (KR) 10-2007-0096877

(51) Int. Cl. G06F 17/30

(52) U.S. Cl. 707/10; 707/E17.032

(57) ABSTRACT

A terminal device with a function of distributing data, a method and a system for distributing multimedia data using the same are provided. In order to reduce loads of a core network and effectively use a network, the terminal device includes: a storage unit storing data; a data request monitor sensing a request for the data which is transmitted from another terminal device through a network; and a data controller determining whether the requested data is stored in the storage unit in response to the request for the data and transmitting the data to the requesting terminal device through the network when the requested data is stored in the storage unit. Accordingly, it is possible to expect an effect as in a case where a plurality of data severs are installed with low costs.

### CROSS-REFERENCE TO RELATED APPLICATIONS

This application claims the priorities of Korean Patent Application No. 2006-121587 filed on Dec. 4, 2006 and of Korean Patent Application No. 2007-96877 filed on Sep. 21, 2007 in the Korean Intellectual Property Office, the disclosure of which is incorporated herein by reference.

### BACKGROUND OF THE INVENTION

1. Field of the Invention

The present invention relates to terminal devices with a function of distributing data and a method and a system for distributing multimedia data using the same, and more particularly, to terminal devices with a function of distributing data capable of enabling a load of a network to decrease by storing received data by using a storage function of terminal devices connected to a network, sensing a request for data, when another terminal device in the network makes a request for data, and transmitting the data to the requesting terminal device, and a method and a system for distributing multimedia data using the same.

This work was supported by the IT R&D program of MIC/IITA [2005-S-102-02, Carrier Class Ethernet Technology]

2. Description of the Related Art

As techniques have been developed, various electronic devices are integrated into a network. Then, a networking function is added to a personal video recorder (PVR), a television (TV), a personal computer (PC), and the like, which use multimedia data. A TV with a recording function obtained by combining a PVR and a TV has been launched. An IPTV that transmits TV video data through a network by using an Internet protocol has been also launched. A storage device in which video data is to be stored is generally added to these apparatuses.

Since multimedia information has a larger size than general data, a large amount of traffic is caused, when receiving the multimedia information through a network. Accordingly, it is difficult to transmit high definition images through a network. In addition, since traffic is caused in a core network, efficiency of the entire network deteriorates.

In order to solve this problem, in the past, a plurality of data servers are included in a network. Load balance is achieved with respect to users' requests for accesses to data by storing copies of data in arbitrary servers among the data servers.

FIG. 1 illustrates a configuration of a network to which a plurality of conventional terminal devices are connected. Referring to FIG. 1, a plurality of data servers 100 and a plurality of terminal devices 120, 130, and 140 are connected to a network 110. In this case, when a terminal device receives data from a distant data server 100 through the network 110 and when another terminal device desires to receive the same data, the latter terminal device receives the data from the distant data server 100, again.

### SUMMARY OF THE INVENTION

When a network is repeatedly used so that a plurality of terminal devices receive the same data, loads of the network are increased.

In a conventional technique, when a plurality of servers constructed with expensive equipments are used, since the plurality of servers have to be operated and the stability of the servers have to be secured, it is disadvantageous that high costs are needed.

Accordingly, an aspect of the present invention provides a terminal device with a function of distributing data capable of effectively using a network by reducing loads of a core network by using a storage function of terminal devices connected to the network.

According to an aspect of the present invention, there is provided a terminal device with a function of distributing data, the terminal device comprising: a storage unit storing data; a data request monitor sensing a request for the data which is transmitted from another terminal device through a network; and a data controller determining whether the requested data is stored in the storage unit in response to the request for the data and transmitting the data to the requesting terminal device through the network when the requested data is stored in the storage unit.

In the above aspect of the present invention, the storage unit may store the data transmitted through the network. Alternatively, the storage unit may receive and store broadcasting data through an antenna or cable.

In addition, the storage unit may transform the broadcasting data into digital data and store the digital data, when receiving the broadcasting data through the antenna or cable.

In addition, the controller may transmit a data request message to another terminal through the network. When the data is transmitted in response to the request message, the controller may play the transmitted data.

In addition, the controller may control data transmitted through the network or broadcasting data received through the antenna or cable.

According to another aspect of the present invention, there is provided a multimedia data distribution system comprising: a data server transmitting stored data through a network; a terminal device storing data transmitted from the data server in a storage device included therein, determining whether the requested data is stored in the storage device in response to a request for data from another terminal device connected to the network, and transmitting the data to the requesting terminal device when the requested data is stored in the storage device; and a storage controller designating data to be stored in the storage device of the terminal device among the data transmitted from the data server.

In the above aspect of the present invention, the storage controller may transmit information on the terminal device in which the data is stored, when the request for the data is received.

In addition, the terminal device may receive and play the requested data from another terminal in which the requested data is stored by transmitting a data request message to the network.

According to another aspect of the present invention, there is provided a method of distributing multimedia data, the method comprising: a first step of receiving data from a data server through a network and storing the data in a terminal device; a second step of sensing whether another terminal device connected to the network requests the data to be provided; a third step of determining whether the requested data is stored, when the request for the data is sensed; and a fourth step of transmitting the requested data to the requesting terminal device, when the requested data is stored in the terminal device.

According to another aspect of the present invention, there is provided a method of distributing multimedia in a system in which a plurality of terminal devices that receives broadcasting data through an antenna or cable are connected through a network, the method comprising: a first step of receiving and storing the broadcasting data through the antenna or cable by using a tuner; a second step of sensing a broadcasting request message transmitted from another terminal device through the network; a third step of determining whether the requested broadcasting data is the same as the stored broadcasting data; and a fourth step of transmitting the broadcasting data to the requesting terminal device, when it is determined that the broadcasting data which is the same as the requested broadcasting data is stored.

In the above aspect of the present invention, the first step may further comprise: a step of recording the received broadcasting data; and a step of transforming the recorded broadcasting data into multimedia digital information and storing the multimedia digital information.

In addition, the first step may further comprise a step of selecting types of broadcasting channels to be stored in the plurality of terminal devices through the antenna or cable.

As described above, in the terminal devices with the function of distributing data according to an embodiment of the present invention, the method and the system for distributing multimedia data using the same, it is possible to obtain an effect as in a case where a plurality of data servers are installed by using terminal devices with a function of storing data instead of installing a plurality of servers. In addition, in the terminal devices with the function of distributing data according to an embodiment of the present invention, the method and the system for distributing multimedia data using the same, since data is transmitted from a geographically neighboring device, it is possible to reduce loads of the entire network.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 illustrates a configuration of a network to which a plurality of conventional terminal devices are connected;

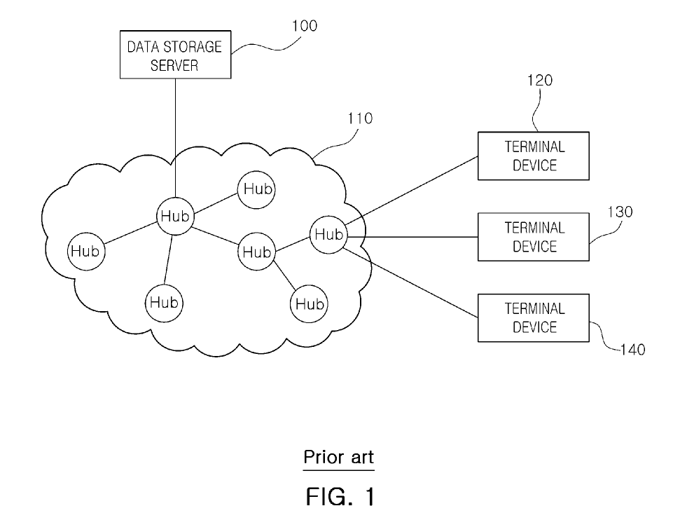

FIG. 2 illustrates a configuration of a network to which a plurality of terminal devices with a function of distributing data according to an embodiment of the present invention;

FIG. 3 illustrates a structure of a terminal device with a function of distributing data according to an embodiment of the present invention;

FIG. 4 illustrates a configuration in which various terminal devices according to an embodiment of the present invention are connected to an IPTV server through a network;

FIG. 5 illustrates a configuration of a system in which a plurality of terminal devices that receive broadcasting data through an antenna or cable are connected to a network;

FIG. 6 is a flowchart of a method of distributing multimedia data according to a first embodiment of the present invention; and

FIG. 7 is a flowchart of a method of distributing multimedia data according to a second embodiment of the present invention.

### DETAILED DESCRIPTION OF THE PREFERRED EMBODIMENT

Exemplary embodiments of the present invention will now be described in detail with reference to the accompanying drawings. When it is determined that the detailed descriptions of the known techniques or structures related to the present invention depart from the scope of the invention, the detailed descriptions will be omitted.

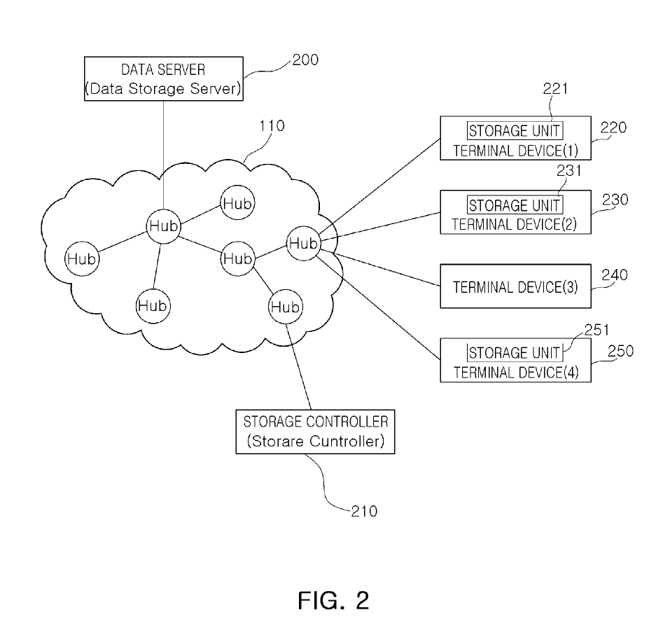

FIG. 2 illustrates a configuration of a network to which a plurality of terminal devices with a function of distributing data according to an embodiment of the present invention.

Referring to FIG. 2, a data server 200, a storage controller 210, terminal devices 220, 230, and 250 with a storage unit, and a terminal device 240 without a storage unit are connected to a network 110.

In general, the network 110 has a configuration in which a plurality of network equipments are intertwined. Equipments such as hubs, switches, routers, and the like are used as the equipments for connection points. In the present invention, the equipments are commonly referred to as by hubs.

The data server 200 transmits data to a client such as a terminal device in response to a request for data, while storing multimedia data. Accordingly, the plurality of terminal devices 220, 230, 240, and 250 connected to the network serves to receive data from the data server 200 and play multimedia data. In general, the terminal devices 220, 230, 240, and 250 receives data from the data server 200 in a streaming manner in real time and plays multimedia.

Typically, many users tend to use the multimedia data at similar times. For example, in case of a sports game such as a world cup game, people who do not watch the world cup game watch the world cup game through a video on demand (VOD) by accessing a homepage of a broadcasting station or portal server within a several hours after broadcasting the world cup game.

In this case, in a conventional method, each of the terminal devices 220, 230, 240, or 250 has to receive data from the data server 200. As a result, since data is transmitted via a plurality of hubs, many network resources are needed.

However, in the present invention, in case of terminal devices 220, 230, and 250 with a storage function, when receiving multimedia data from the data server 200 and playing the received multimedia data, a terminal device (1) 220 stores the received multimedia data in the storage unit 221. When another terminal device (2) 230 connected to the network makes a request for the multimedia data, the requesting terminal device (2) 230 does not receive data from the distant data server 200 but receives multimedia stored in the storage unit 221 of a near terminal device (1) 220 so as to play the multimedia.

The storage controller 210 controls which data is stored in the terminal devices 220, 230, and 250 connected to the network. For example, when the terminal devices 220, 230, and 250 receive respective data from data server 200, the storage controller 210 can instruct a storage unit of each terminal device to store the received data. When the data server 200 transmits various data to the terminal devices 220, 230, and 250, the storage controller 210 designates data to be stored in the terminal devices.

In addition, the storage controller 210 stores information on which data is transmitted and stored in the terminal devices. Then, when a terminal device makes a request for data, the storage controller 210 searches for a terminal device in which the requested data is stored. When the data is not stored in any terminal device, the storage controller 210 instructs the data server 200 to transmit data.

The terminal 240 without the storage function among the terminal devices does not store data. However, the terminal 240 can receive and play data by requesting another terminal device to provide data.

When it is assumed that data required by a terminal device 220 is stored in another terminal device 230, the terminal device 220 that requires the data transmits a data request message to a local area network (LAN). When the data request message is transmitted, the storage controller 210 of the network transmits information on the terminal device 230 in which the requested data is stored and transmits the data request message to the terminal device 230 in which the requested data is stored. When there is no storage controller 210, the terminal device 220 that requires data can directly transmit the data request message through the network.

When the data request message is transmitted through the network, the terminal device 230 in which the data is stored senses the data request message. The request for data may be sensed by receiving the data request message transmitted by the storage controller 210. Alternatively, the network may directly sense the request for data.

When sensing the request for data, the terminal device 230 determines whether the requested data is stored in the storage unit. Then, when the data is stored in the storage unit, the data is transmitted to the terminal device 220 that requires data.

The most popular network interface used for a LAN is Ethernet. The Ethernet has a characteristic in which a physical address of a destination is basically recognized through a broadcasting message of a network to which the Ethernet belongs.

Accordingly, the terminal device according to the embodiment of the present invention can inquires whether there is another terminal device in which the desirable data is stored by transmitting a broadcasting message to the LAN to which the terminal device belongs, before requesting a VOD server to provide multimedia data. When there is no response within a predetermined time, the terminal device requests the data server 200 to provide multimedia data. It is possible to effectively operate a network by transforming long-distance communication into short-distance communication by using neighboring terminal devices with a storage unit through a simple protocol. Although the terminal device according to the embodiment of the present invention does not have a storage function, when another terminal device has a storage function, the terminal device without the storage function can receive data from the terminal device with the storage function.

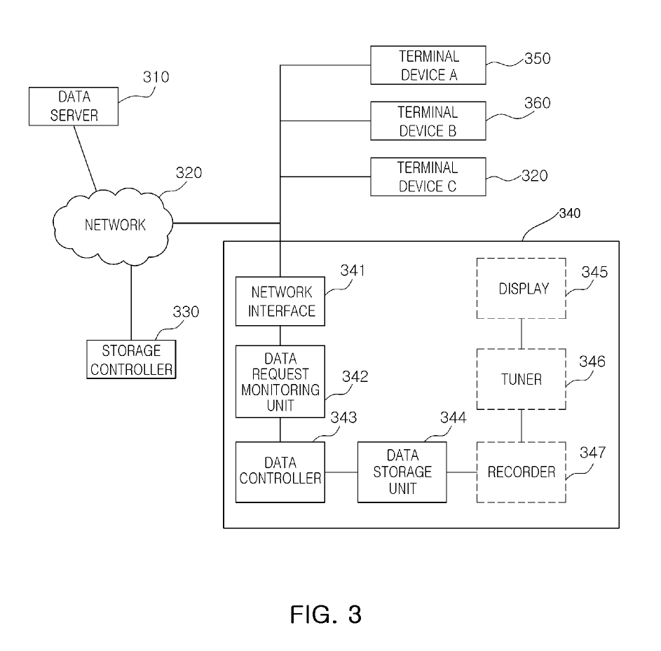

FIG. 3 illustrates a structure of a terminal device with a function of distributing data according to an embodiment of the present invention.

A terminal device 340 with a function of distributing data connected to a network includes a network interface 341, a data request monitor 342, a data controller 343, and a data storage unit 344. When receiving a broadcasting channel through an antenna or cable, the terminal device 340 further includes a tuner 346 or a recorder 347. When a display is integrated into the terminal device 340, the terminal device 340 further includes a display 345. In the embodiment, a method that can be applied to terminal devices without a storage device will be suggested. Accordingly, in this case, it is possible to construct a structure without the data storage unit 344.

The network interface 341 executes communication of the network. In addition, the network interface 341 transmits a message for making a request for data to the LAN to which the terminal device belongs and receives data from another terminal device in the LAN in response to the request message.

The data request monitor 342 senses a request for data transmitted from another terminal device of the network. The request for data may be sensed by receiving the data request message that is transmitted by a storage controller 330. In addition, it may be sensed whether the request for data is included in traffic of the network.

The data storage unit 344 stores data transmitted from the data server of the network through the network interface. The data to be stored in the data storage unit 344 is selected by the storage controller 330 and stored. The storage controller 330 may be connected to the network. Alternatively, the storage controller 330 may be installed in the data server 310.

The data controller 343 determines whether the requested data is stored in the data storage unit 344. When the requested data is stored in the data storage unit 344, the data controller 343 transmits the requested data to the terminal device that requires the data through the network.

When receiving a broadcasting channel through an antenna or cable, a broadcasting channel is selected through the tuner 346. The broadcasting channel selected by the tuner 346 is recorded by the recorder 347. The recorded broadcasting channel is transformed into digital information and stored in the data storage unit 344. In addition, when the display device is integrated into the terminal device, the terminal device includes the display 345 for outputting the broadcasting channel.

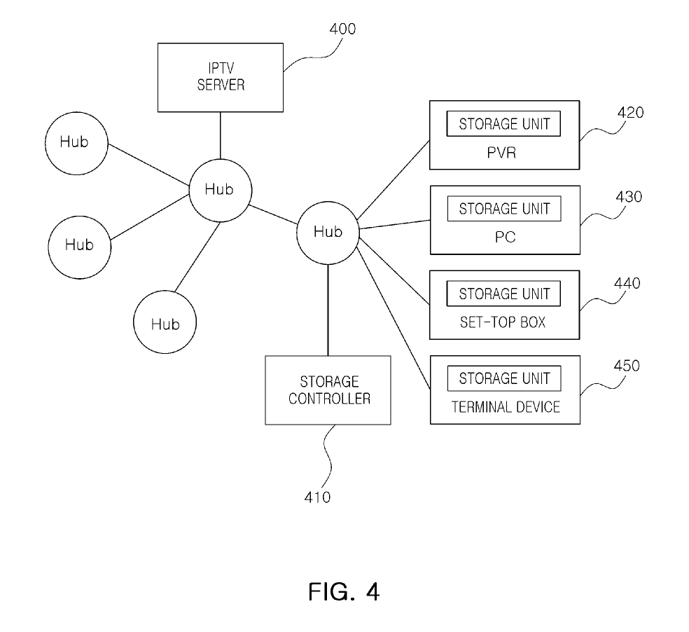

FIG. 4 illustrates a configuration in which various terminal devices according to an embodiment of the present invention are connected to an IPTV server through a network.

In an IPTV service, multi-channel broadcasting data is transformed into an Internet protocol (IP) packet-data and provided through the network. In order to provide this service, an IPTV server 400, terminal devices 420, 430, 440, and 450 with a storage device, and a storage controller 410 are connected through the network. Various terminal devices connected to the network have a network communication function in addition to a storage function. The terminal devices with these functions may be personal video recorder (PVR) 420, a general personal computer (PC) 430, a set-top box 440, and the like.

A case where broadcasting data provided by three broadcasting companies (American Broadcasting Company (ABC), National Broadcasting Company (NBC), and Columbia Broadcasting System (CBS)) is supplied through the IPTV service will be explained.

When the PVR 420, the PC 430, and the set-top box 440, which are connected to the network, have a storage capacity of 24 hours, the PVR 420, the PC 430, and the set-top box 440 can continuously store broadcasting data provided by ABC, NBC, and CBS, respectively. Since broadcasting data for one day are stored for each channel, a user can watch the broadcasting data of three sky wave broadcasting stations by using another terminal device connected to the LAN by allowing the terminal device to receive the broadcasting data from the PVR 420, the PC 430, and the set-top box 440 through the LAN without requesting the IPTV server to provide the broadcasting data.

In another example, it is assumed that there are one hundred households using the IPTV service through terminal devices for receiving the IPTV service with the same performance in an apartment complex. When one hundred of channels are each stored in the one hundred households, it is possible to watch broadcasting data of the one hundred channels within 24 hours after broadcasting the broadcasting data through the intranet communication of the apartment complex. At this time, the storage controller 410 controls a method of distributing broadcasting data to the households. In addition, the storage controller 410 may be included in the IPTV server. Alternatively, the storage controller 410 may be connected to the network separately from the IPTV server so as to control data to be stored.

This service may be applied to a multimedia server such as a VOD server similar to the IPTV server.

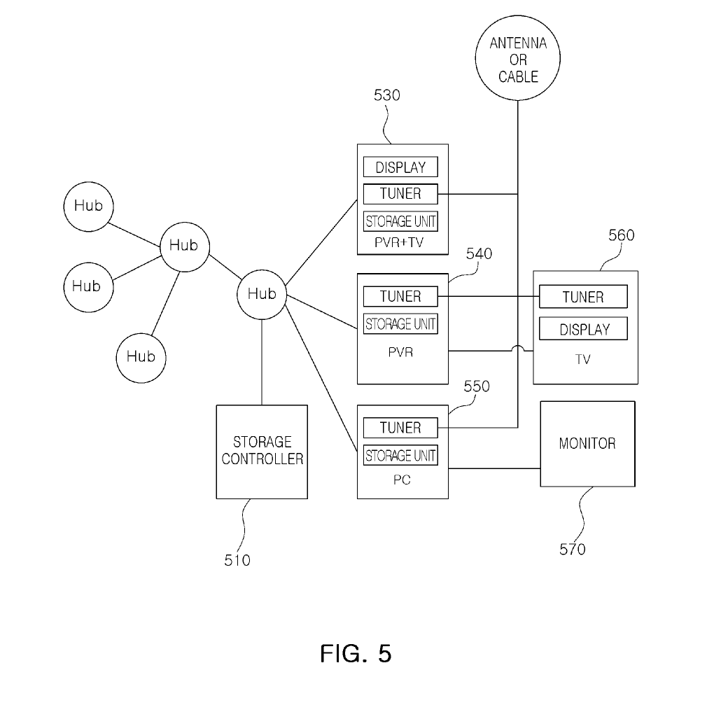

FIG. 5 illustrates a configuration of a system in which a plurality of terminal devices that receive broadcasting data through an antenna or cable are connected to a network.

The present invention may be also applied to a case where terminal devices 530, 540, and 550 which receive broadcasting data through an antenna or cable are connected to the network in addition to a case where multimedia is transmitted and stored through the network by using an IPTV. A terminal device 530 obtained by combining a PVR and a TV, a PVR 540 with a networking function, and a PC 550 equipped with a TV-card that is a tuner receive broadcasting data through an antenna or cable and store data as digital information. The broadcasting data to be stored in the terminal devices 530, 540, and 550 is controlled by the storage controller 510. When there is no storage controller 510, the terminal devices 530, 540, and 550 report a channel to be recorded to one another by using the network. Accordingly, the terminal devices in the LAN are allowed to record different channels.

When broadcasting data is stored in the terminal devices 530, 540, 550, another terminal device makes a request for data through the LAN, receives the data from a terminal device in which the requested data is stored, and play the received data without receiving the broadcasting data from a distant data server or through an antenna or cable even after the broadcasting time is elapsed.

As a result, although an individual terminal device has a capacity for storing broadcasting data for a predetermined period through a channel, it is possible to expect that a plurality of channels are recorded and played for a long time through the network.

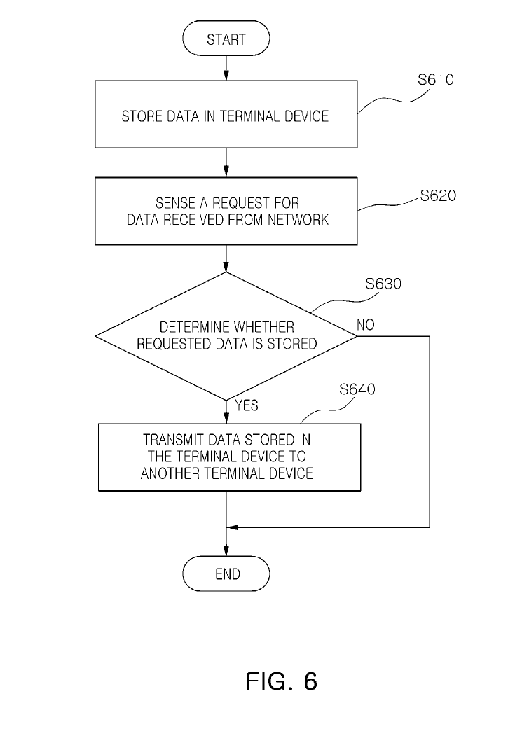

FIG. 6 is a flowchart of a method of distributing multimedia data according to a first embodiment of the present invention.

A terminal device with a storage function receives data from a data server and stores the received data (S610).

The terminal device in which the data is stored can transmit data similarly to a server, when another terminal device connected to the network requests the terminal device to provide data. Accordingly, it is sensed whether another terminal device connected to the network requests the terminal device to provide data (S620).

When another terminal device requests the terminal device to provide data, it is determined whether the requested data is stored (S630).

When the requested data is stored, the data stored in the storage unit is transmitted to the requesting terminal device (S640).

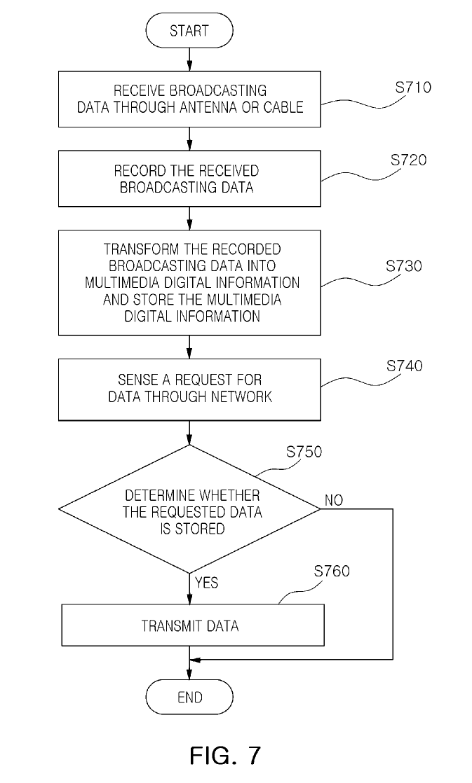

FIG. 7 is a flowchart of a method of distributing multimedia data according to a second embodiment of the present invention.

In the second embodiment, when terminal devices that receive broadcasting data through an antenna or cable are connected to a network, broadcasting data received through the antenna or cable is stored. The broadcasting data is transmitted, when another terminal device of the network requests the terminal device to provide data.

The terminal device connected to the network receives broadcasting data transmitted through the antenna or cable by using a tuner (S710).

When the broadcasting data is received, the received broadcasting data is recorded (S720). The recorded broadcasting data is transformed into multimedia digital information and stored (S730).

The terminal device in which the broadcasting data is stored senses whether another terminal device makes a request for data (S740).

When the request for the data is sensed, it is determined whether the requested data is stored (S750).

When the requested data is stored, the data is transmitted to the requesting terminal device (S760).

While the present invention has been shown and described in connection with the exemplary embodiments, it will be apparent to those skilled in the art that modifications and variations can be made without departing from the spirit and scope of the invention as defined by the appended claims.

What is claimed is:

1. A terminal device with a function of distributing data, the terminal device comprising:
a storage unit storing data;
a data request monitor sensing a request for the data which is transmitted from another terminal device through a network; and
a data controller determining whether the requested data is stored in the storage unit in response to the request for the data and transmitting the data to the requesting terminal device through the network when the requested data is stored in the storage unit.

2. The terminal device of claim 1, wherein the storage unit stores the data transmitted through the network.

3. The terminal device of claim 1, wherein the storage unit receives and stores broadcasting data through an antenna or cable.

4. The terminal device of claim 3, wherein the storage unit transforms the broadcasting data into digital data and stores the digital data.

5. The terminal device of claim 1, wherein the controller transmits a data request message to another terminal through the network.

6. The terminal device of claim 5, wherein the controller plays the transmitted data in response to the request message.

7. The terminal device of claim 2, wherein the storage unit further includes a storage controller controlling the type and amount of the data transmitted through the network.

8. The terminal device of claim 3, wherein the storage unit further includes a storage controller controlling data to be stored among the received broadcasting data.

9. A multimedia data distribution system comprising:
a data server transmitting stored data through a network;
a terminal device storing data transmitted from the data server in a storage device included therein, determining whether the requested data is stored in the storage device in response to a request for data from another terminal device connected to the network, and transmitting the data to the requesting terminal device when the requested data is stored in the storage device; and
a storage controller designating data to be stored in the storage device of the terminal device among the data transmitted from the data server.

10. The multimedia data distribution system of claim 9, wherein the storage controller transmits information on the terminal device in which the data is stored, when the request for the data is received.

11. The multimedia data distribution system of claim 10, wherein the terminal device receives and plays the requested data from another terminal in which the requested data is stored by transmitting a data request message to the network.

12. A method of distributing multimedia data, the method comprising:
a first step of receiving data from a data server through a network and storing the data in a terminal device;
a second step of sensing whether another terminal device connected to the network requests the data to be provided;
a third step of determining whether the requested data is stored, when the request for the data is sensed; and
a fourth step of transmitting the requested data to the requesting terminal device, when the requested data is stored in the terminal device.

13. The method of claim 12, wherein the first step further comprises a step of designating data to be stored in the terminal device.

14. A method of distributing multimedia in a system in which a plurality of terminal devices that receives broadcasting data through an antenna or cable are connected through a network, the method comprising:
a first step of receiving and storing the broadcasting data through the antenna or cable by using a tuner;
a second step of sensing a broadcasting request message transmitted from another terminal device through the network;
a third step of determining whether the requested broadcasting data is the same as the stored broadcasting data; and
a fourth step of transmitting the broadcasting data to the requesting terminal device, when it is determined that the broadcasting data which is the same as the requested broadcasting data is stored.

15. The method of claim 14, wherein the first step further comprises:
a step of recording the received broadcasting data; and
a step of transforming the recorded broadcasting data into multimedia digital information and storing the multimedia digital information.

16. The method of claim 14, wherein the first step further comprises a step of selecting types of broadcasting channels to be stored in the plurality of terminal devices through the antenna or cable.
